(19) United States
(12) Patent Application Publication
(10) Pub. No.: US 2011/0183536 A1
(43) Pub. Date: Jul. 28, 2011

(54) SWITCH CONTACT AND AUDIO JACK WITH THE SAME

(75) Inventor: Yao-Ting Wang, Taipei (TW)

(73) Assignee: CHENG UEI PRECISION INDUSTRY CO., LTD., Taipei (TW)

(21) Appl. No.: 12/693,635

(22) Filed: Jan. 26, 2010

(51) Int. Cl. H01R 29/00; H01R 33/96

(52) U.S. Cl. 439/188; 200/51.09

(57) ABSTRACT

An audio jack adapted to be inserted into an audio plug for switch an audio function includes a housing, a switch contact and a signal contact. The housing includes a main portion, a mating portion projected from a front of the main portion and a tunnel longitudinally formed in the housing. The switch contact includes an engaging portion engaged with the housing, and a first contact portion extended to the tunnel. The signal contact includes an engaging portion engaged with the housing, and a second contact portion extended into the tunnel. The first contact portion and second contact portion connect to different positions of a lateral surface of the audio plug for switching the audio function while the audio plug is completely plugged into the tunnel of the housing.

### BACKGROUND OF THE INVENTION

1. Field of the Invention

The present invention relates to an audio jack, more specifically, to an audio jack with a switch contact.

2. The Related Art

Nowadays, many electronic apparatuses have audio function for transmitting an acoustic signal to a louder speaker through engagement of an audio jack of the electronic apparatuses and an audio plug of the louder speaker, by plugging an audio plug of the louder speaker into the audio jack. Please refer to FIG. 5 showing a conventional audio jack 100′ including an insulating housing 1′, a plurality of signal contacts 2′ and a clip-shaped switch contact 3′.

The insulating housing 1′ defines a plurality of slots 12′ adapted to receive the signal contacts 2′, a tunnel 13′ longitudinally penetrating the housing 1′ from the front to the rear for being plugged an audio plug (not shown in the figure), and a channel 11′ opened on the rear of a bottom surface thereof adapted to receive the clip-shaped switch contact 3′.

If the audio plug plugs into the insulating housing 1′ from the front thereof, then the signal contacts 2′ laterally can contact the audio plug and the clip-shaped switch contact 3′ can connect the distal point of the audio plug for switching on the audio function.

However, because the clip-shaped switch contact 3′ is vertically received in the channel 11′ formed in the rear of the housing 1′, the length of the audio jack 100′ will be increased. Hence, it can hardly be compact size.

### SUMMARY OF THE INVENTION

An object of the present invention is to provide an audio jack with a compact size.

According to the invention, the audio jack is adapted to be plugged into an audio plug having a first terminal and a second terminal located in different axial positions for switching an audio function. The audio jack has a housing, a switch contact, a first signal contact and a second signal contact.

The housing has a main portion and area mating portion. The main portion defines a front wall, a rear wall, a first slot and a second slot. The mating portion is projected from the front wall of the main portion. A tunnel is penetrated the mating portion and longitudinally extended into the main portion. The tunnel is connected to the first slot and the second slot. A groove is longitudinally formed on a rear portion of the main portion and connected to the tunnel. A pair of first fixing slots are formed beside the groove.

The switch contact has a first plate, a first contact portion extended to the tunnel through the groove, and a pair of fixed tabs engaged into the first fixing slots respectively. The first signal contact has a second plate received in the first slot and a second contact portion extended into the tunnel. The second signal contact has a third plate received in the second slot and a third contact portion extended into the tunnel.

While the audio plug is completely inserted in the tunnel, the third contact portion of the second signal contact connects to a radial position of the second terminal of the audio plug, the second contact portion of the first signal contact and the first contact portion of the switch contact connect to different radial positions of the first terminal of the audio plug for switching the audio function.

Another object of the present invention is to provide a switch contact adapted to mount to a housing of an audio jack for a compact size purpose.

According to the invention, the switch contact has a transverse plate, a longitudinal elastic arm, a contact portion and a pair of fixing tabs. The longitudinal elastic arm is reversely extended from a middle portion of a front edge of the transverse plate. The contact portion is extended from the free end of the elastic arm. The fixing tabs are extended from the transverse plate and positioned at both sides of the transverse plate respectively for engaging with the housing.

Another object of the present invention is to provide an audio jack with a compact size.

According to the invention, the audio jack is adapted to be inserted into an audio plug for switch an audio function. The audio jack has a housing, a switch contact and a signal contact. The housing has a main portion, a mating portion projected from a front of the main portion and a tunnel opened on the mating portion and longitudinally extended into the main portion.

The switch contact has an engaging portion engaged with the housing, and a first contact portion extended to the tunnel. The signal contact having an engaging portion engaged with the housing, and a second contact portion extended into the tunnel.

While the audio plug is completely plugged into the tunnel of the housing, the first contact portion and second contact portion connect to different positions of a lateral surface of the audio plug for switching the audio function.

According to the switch contact is horizontally mounted to the housing and the first contact portion is longitudinally extended into the tunnel and laterally connected the radial position of the audio plug, the length of the audio jack can be reduced to achieve a compact size.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of an audio jack according to the present invention;

FIG. 2 is a perspective view of an insulating housing of the audio jack shown in FIG. 1;

FIG. 3 is a perspective view of the audio jack shown in FIG. 1;

FIG. 4 is a perspective view showing the connection between the signal contacts and an audio plug; and

FIG. 5 is a perspective view showing a conventional audio jack.

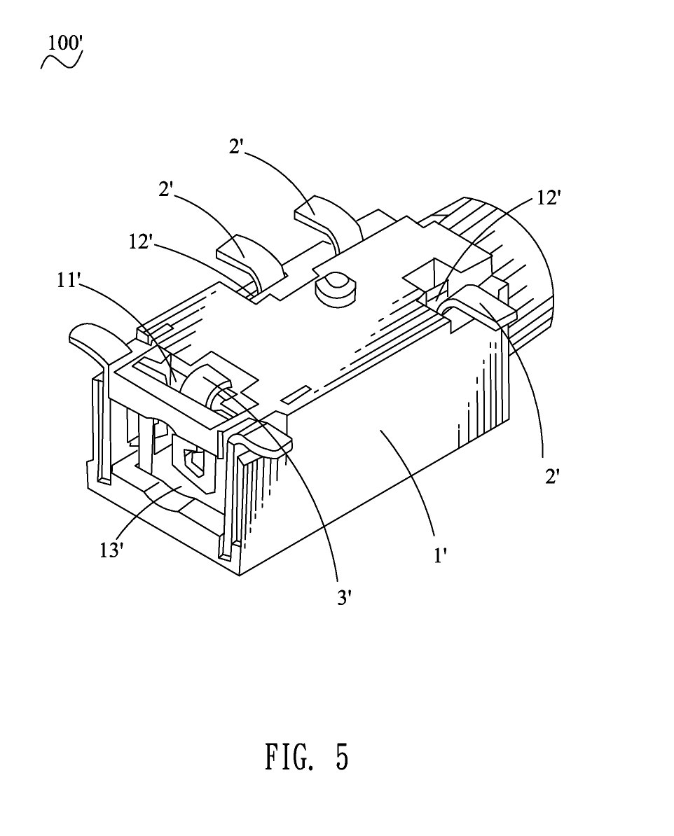

### DETAILED DESCRIPTION OF THE PREFERRED EMBODIMENT

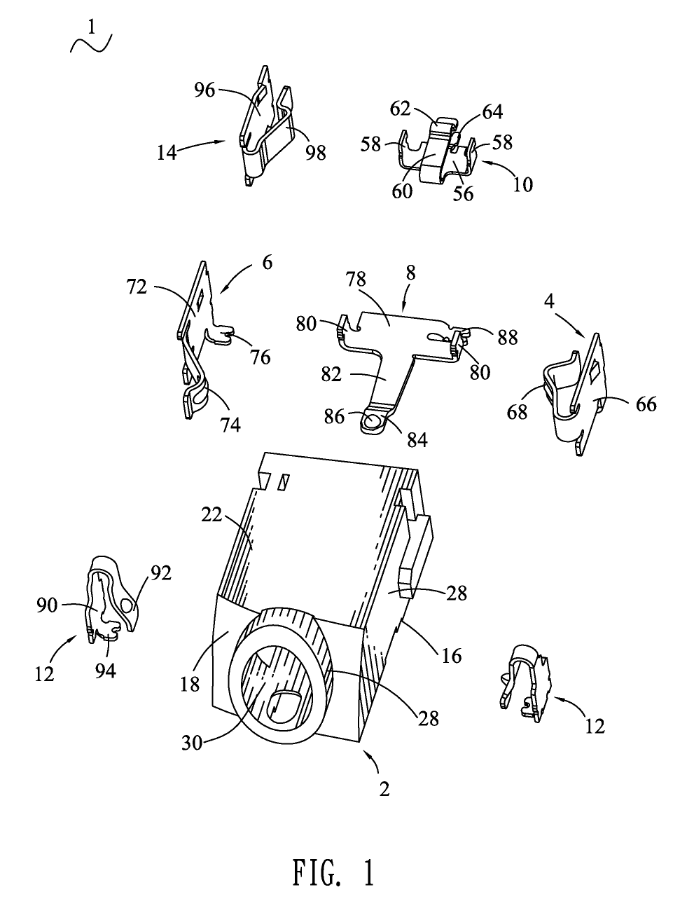

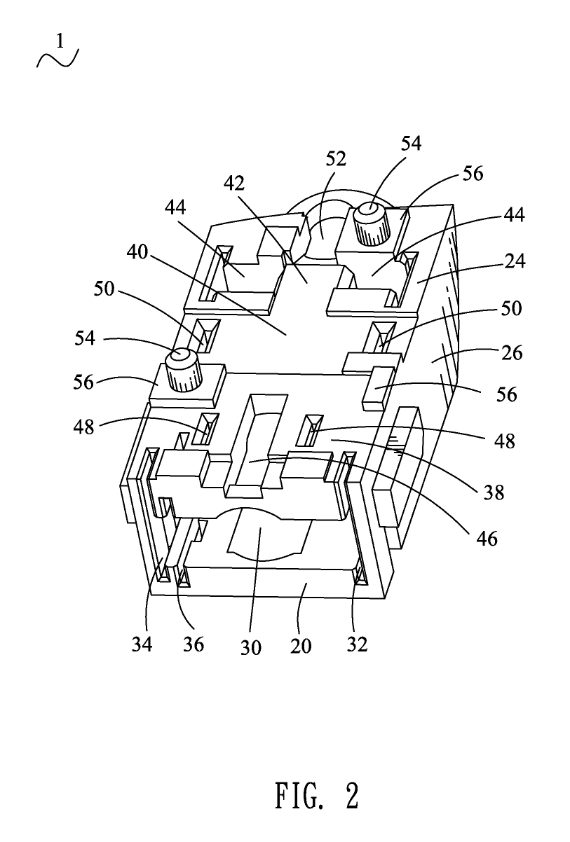

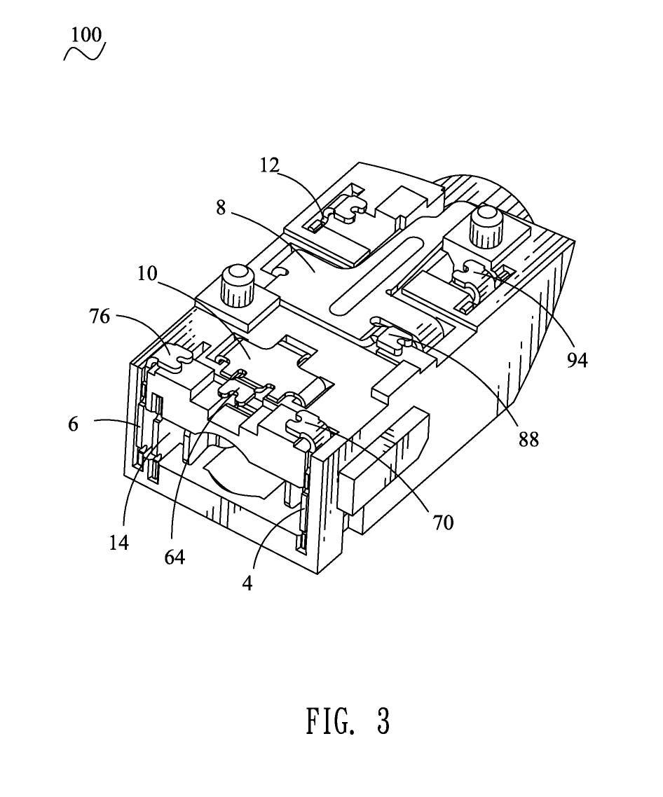

Please refer to FIG. 1 to FIG. 3. FIG. 1 is an exploded view of an audio jack. FIG. 2 is a perspective view of an insulating housing of the audio jack. FIG. 3 is a perspective view of the audio jack. The audio jack 1 has a insulating housing 2, a first signal contact 4, a second signal contact 6, a third signal contact 8, a switch contact 10, a pair of grounding contacts 12 and a retention contact 14.

The insulating housing 2 has a main portion 16 defining a front wall 18, a rear wall 20 opposite to the front wall 18, a top wall 22, a bottom wall 24 opposite to the top wall 22, and opposite side walls 26, and a cylindrical mating portion 28 projected from the front wall 18 of the main portion 16. Especially, the main portion 16 of the insulating housing 2 is of a rectangular shape.

The insulating housing 2 defines a tunnel 30 longitudinally extended from the cylindrical mating portion 28 to the rear wall 20 thereof. The rear wall 20 of the insulating housing 2 defines a first slot 32 and a second slot 34 adjacent to the side walls respectively, and a third slot 36 beside the second slot 34.

The bottom wall 24 of the insulating housing 2 defines a switch recess 38 on the rear thereof, a transverse recess 40 on the middle thereof, and a longitudinally recess 42 and a pair of receiving holes 44 on the front thereof. The first recess 38 defines a longitudinally groove 46 connected to the tunnel 30 and a pair of first fixing slots 48 beside the groove 40.

The transverse recess 40 defines a pair of second fixing slots 50 adjacent to the side walls 26 respectively. One end of the longitudinally recess 42 connects to a middle portion of the transverse recess 40. A bottom portion of the cylindrical mating portion 28 defines a through hole 52 connected to the tunnel 30 and the other end of the longitudinally recess 42. The pair of the receiving holes 44 is formed beside the longitudinally recess 42.

The bottom wall 24 further defines a plurality of posts 54 for being plugged into corresponding holes of a printed circuit board and a plurality of blocks 56 for being mounted to a mounting surface of the printed circuit board (not shown in figures).

The switch contact 10 has a first plate 56, a pair of second fixing tabs 58 vertically extending from opposite side edges of the first horizontal plate 56, a first elastic arm 60 reversely extending from a middle portion of a front edge of the first plate 56, a first contact portion 62 extending from the free end of the first elastic arm 60, and a first soldering portion 64 extending from a middle portion of a rear edge of the first plate 56.

The first signal contact 4 has a second plate 66, an second contact portion 68 reversely extending from a front edge of the second plate 66, and a second soldering tab 70 extending from a bottom edge of the second plate 66. The second contact 6 has a third plate 72, a third contact portion 74 extending from a front edge of the third plate 72, and a third soldering tab 76 extending from a bottom edge of the third plate 72.

The third contact 8 has a fourth plate 78, a pair of second fixing tabs 80 vertically extending from the opposite side edges of the fourth plate 78, an second elastic arm 82 extending from a middle portion of a front edge of the fourth plate 78, a fourth contact portion 84 extending from the free end of the second elastic arm 82, a contact protrusion 86 projecting from the fourth contact portion 84, and a fourth soldering tab 88 beside one of the second fixing tabs 80.

Each of the grounding contacts 12 has a fifth plate 90, a fifth contact portion 92 reversely extending from a top edge of the fifth plate 90, and a fifth soldering tab 94 extending from a bottom edge of the fifth plate 90. The retention contact 14 has a sixth plate 96 and a sixth contact portion 98 reversely extending from a front edge of the sixth plate 96.

Especially, each of the first contact portion 62, the second contact portion 68, the third contact portion 74, the fourth contact portion 84, the fifth contact portion 92, and the sixth contact portion 98 is of a curve. The first signal contact 4, the second signal contact 6, and the retention contact 14 are vertically inserted into the first slot 32, the second slot 34 and the third slot 36 from the rear wall 20 of the insulating housing 2 respectively.

Especially, each of the second plate 66, the third plate 72 and the sixth plate 96 function as an engaging portion for engaging into the insulating housing 2. The grounding contacts 12 are vertically inserted into the receiving holes 44 from the bottom wall 24 respectively. The fifth plate 90 of each grounding contact 12 functions as an engaging portion for engaging into the insulating housing 2. Hence, the second contact portion 68, the third contact portion 74, the fifth contact portion 92 and the sixth contact portion 98 are projected into the tunnel 30.

The fourth plate 78 of the third contact 8 is horizontally received in the transverse recess 40, the second elastic arm 82 is received in the longitudinal recess 42, the fourth contact portion 84 is projected into the tunnel 30 through the through hole 52, and the second fixing tabs 80 are inserted into the second fixing slots 50 respectively.

The first plate 82 of the switch contact 10 is horizontally received in the switch recess 38, the first fixing tabs 58 are inserted in the first fixing slots 48, and the first elastic arm 60 is received in the longitudinal groove 46, and the first contact portion 62 is projected into the tunnel 30. Especially, each of the first soldering tab 64, the second soldering tab 70, the third soldering tab 76, the fourth soldering portion 88 and the fifth soldering tab 94 extends beyond the bottom wall 24 of the insulating housing 2 for contacting a corresponding contact pad of the printed circuit board (not shown in figures).

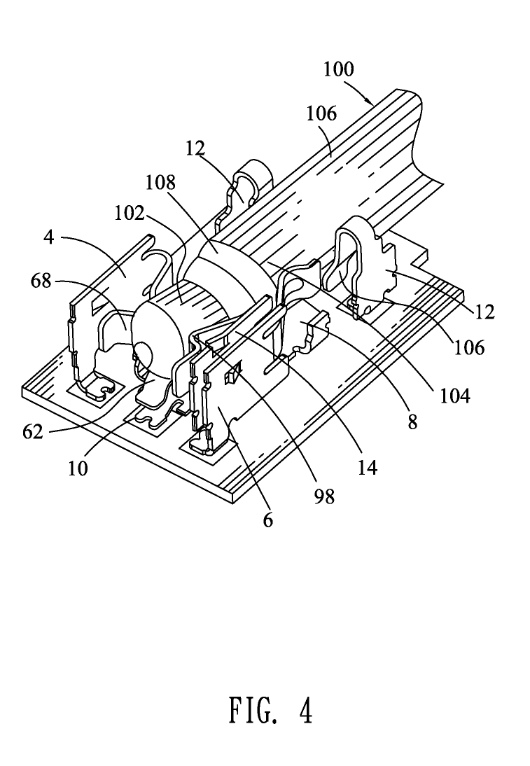

Please refer to FIG. 4. An audio plug 100 has a first terminal 102, a second terminal 104 and a third terminal 106 being located in different axial positions. The first terminal 102, the second terminal 104 and the third terminal 106 are insulated from each other by an insulating member 108 located therebetween.

If the audio plug 100 is plugged into the tunnel 30 of the audio jack 1 from the cylindrical mating portion 28, the fifth contact portions 92 of the grounding contact 12 connected to opposite radial positions of the third terminal 106. The third contact portion 74 of the second contact 6 connected to the a radial position of the second terminal 104.

The second contact portion 68 of the first contact 4 and the first contact portion 62 of the switch contact 10 connected to different radial positions of the first terminal 96 for switching on the audio function. Especially, the sixth contact portion 98 of the retention contact 14, the second contact portion 68 of the first contact 4, and the first contact portion 62 of the switch contact 10 are connected to different radial positions of the first terminal 96 for holding the audio plug 100.

As described above, according to the switch contact 10 being horizontally mounted in the switch recess 38 and the first contact portion 62 being longitudinally extended into the tunnel 30 and laterally connected the radial position of the audio plug 100, the length of the audio jack 1 can be reduced for the compact purpose.

Furthermore, the present invention is not limited to the embodiments described above; diverse additions, alterations and the like may be made within the scope of the present invention by a person skilled in the art. For example, respective embodiments may be appropriately combined.

What is claimed is:

1. An audio jack adapted to be plugged into an audio plug having a first terminal and a second terminal located in different axial positions, comprising:
a housing having a main portion defining a front wall, a rear wall, a first slot, a second slot, a mating portion projecting from the front wall, a tunnel penetrated the mating portion and longitudinally extended into the main portion and connected to the first slot and the second slot, a groove longitudinally formed on a rear portion of the main portion and connected to the tunnel, and a pair of first fixing slots beside the groove;
a switch contact having a first plate, a first contact portion extended to the tunnel through the groove, and a pair of fixed tabs engaged into the first fixing slots respectively;
a first signal contact having a second plate received in the first slot and a second contact portion extended into the tunnel;
a second signal contact having a third plate received in the second slot and a third contact portion extended into the tunnel; and
wherein the third contact portion of the second signal contact connects to a radial position of the second terminal of the audio plug, the second contact portion of the first signal contact and the first contact portion of the switch contact connect to different radial positions of the first terminal of the audio plug.

2. The audio jack as claimed in claim 1, wherein the main portion of the housing defining a bottom wall and opposite side walls, the first slot and the second slot are formed on the rear wall and adjacent to the side walls respectively, the groove formed on the rear portion of the bottom wall of main portion.

3. The audio jack as claimed in claim 2, wherein the first plate is horizontally positioned to face the bottom wall of housing and reversely extends a first elastic arm from a middle portion of a front edge thereof, the first elastic arm received in the groove of the housing, the first contact portion extends from the free end of the first elastic arm.

4. The audio jack as claimed in claim 3, wherein the first fixing tabs are vertically extend from opposite edges of the first plate of the switch contact respectively.

5. The audio jack as claimed in claim 4, wherein the second plate and the third plate are vertically received in the first slot and the second slot from the rear wall of the housing respectively.

6. The audio jack as claimed in claim 5, wherein the second contact portion reversely extends from a front edge of the second plate of the first contact, the third contact portion extends from a front edge of the third plate of the second contact and towards the mating portion.

7. The audio jack as claimed in claim 6, wherein the bottom wall of the housing is formed a transverse recess on a middle portion thereof and a longitudinal recess on a front portion thereof, the transverse recess defines a pair of second fixing slots adjacent to the side walls respectively, a bottom portion of the mating portion is formed a through hole connected to the tunnel and the longitudinal recess, a third signal contact has a fourth plate horizontally received in the transverse recess, a second elastic arm extending from the fourth plate and received in the longitudinal recess, a fourth contact portion extending from the free end of the second elastic arm and into the tunnel through the through hole, and a pair of second fixing tabs vertically extending from the fourth plate and engaged into the second fixing slots respectively.

8. The audio jack as claimed in claim 7, wherein the bottom wall of the housing is formed a pair of receiving holes beside the longitudinal recess, a pair of ground contacts received in the receiving holes respectively, each of the grounding contacts having a fifth plate vertically received in each of the receiving holes from the bottom wall, a fifth contact portion reversely extending from a top edge of the fifth plate and into the tunnel.

9. The audio jack as claimed in claim 8, wherein the housing is formed a third slot on the rear wall and adjacent to the second slot, a retention contact having a sixth plate vertically received in the third slot from the rear wall, and a sixth contact portion reversely extending from a front edge of the sixth plate and into the tunnel, the first contact portion, the second contact portion and the sixth contact portion connect to different radial positions of the first terminal of the audio plug.

10. A switch contact adapted to mount to a housing of an audio jack, comprising:
a transverse plate;
an longitudinal elastic arm reversely extending from a middle portion of a front edge of the transverse plate;
a contact portion extending from the free end of the elastic arm; and
a pair of fixing tabs extending from the transverse plate and positioned at both sides of the transverse plate respectively for engaging with the housing.

11. The switch contact as claimed in claim 10, wherein the fixing tabs vertically extend from opposite side edges of the transverse plate.

12. The switch contact as claimed in claim 11, wherein a middle portion of a rear edge of the transverse plate extends a soldering tab.

13. An audio jack adapted to be inserted into an audio plug for switch an audio function, comprising:
a housing comprising a main portion, a mating portion projected from a front wall of the main portion and a tunnel opened on the mating portion and longitudinally extended into the main portion;
a switch contact having an engaging portion engaged with the housing, and a first contact portion extended to the tunnel;
a signal contact having an engaging portion engaged with the housing, and a second contact portion extended into the tunnel; and
wherein the first contact portion and second contact portion connect to different positions of a lateral surface of the audio plug for switching the audio function while the audio plug is completely plugged into the tunnel of the housing.
